(19) United States
(12) Patent Application Publication
(10) Pub. No.: US 2013/0141370 A1
(43) Pub. Date: Jun. 6, 2013

(54) TOUCH KEYPAD MODULE AND INPUT PROCESSING METHOD THEREOF

(71) Applicant: ETURBOTOUCH TECHNOLOGY, INC., Jhongli City (TW)

(72) Inventors: Kuei-Ching WANG, TAOYUAN COUNTY (TW); Ta-Hu LIN, TAIPEI CITY (TW)

(73) Assignee: ETURBOTOUCH TECHNOLOGY, INC., JHONGLI CITY (TW)

(21) Appl. No.: 13/687,935

(22) Filed: Nov. 28, 2012

(30) Foreign Application Priority Data
Dec. 2, 2011 (TW) 100144501

(51) Int. Cl. G06F 3/041

(52) U.S. Cl. CPC G06F 3/041
USPC 345/173

(57) ABSTRACT

A touch keypad module comprises a touch input panel, which includes a touch input surface and physically shows a plurality of input areas. The input areas are defined as the areas on the touch input surface capable of generating effective inputs in a key input mode. The touch input panel operates in the key input mode or a track input mode according to a mode control signal, and processes at least an input signal inputted through the touch input surface.

### CROSS REFERENCE TO RELATED APPLICATIONS

This Non-provisional application claims priority under 35 U.S.C. §119(a) on Patent Application No(s). 100144501 filed in Taiwan, Republic of China on Dec. 2, 2011, the entire contents of which are hereby incorporated by reference.

### BACKGROUND OF THE INVENTION

1. Field of Invention

The present invention relates to an input device and a processing method thereof and, in particular, to a touch input device and a processing method thereof.

2. Related Art

Various kinds of touch input devices have been applied to electronic products in the recent years. For example, mobile phones and tablet computers are mostly configured with a touch screen as their input device. Regarding to a touch screen, the user can simply touch the screen directly to input instructions, control the cursor, or input words by writing. Besides, the touch screen can also show the virtual buttons so that the user can click the virtual buttons to input the corresponding words.

As shown in FIG. 1, a touch screen 1 includes a display device 11, a touch input panel 12, and a housing 13. The display device 11 and the touch input panel 12 are disposed in the housing 13, while the touch input panel 12 is located on a display surface 111 of the display device 11. The touch input panel 12 can be a resistive touch panel, a capacitive touch panel, a supersonic touch panel, or an IR touch panel, wherein the resistive touch input panel is most popular. The resistive touch input panel is mainly divided into 4-wire, 5-wire, 6-wire, and 8-wire types touch input panel. The 4-wire touch input panel has lower manufacturing cost and is fully developed so that it has been widely applied to various products.

The touch input panel 12 mainly includes a conductive glass substrate 121 and a conductive film 122. The conductive glass substrate 121 includes a glass substrate 1211 and a conductive layer 1212 disposed on the glass substrate 1211. The conductive film 122 mainly includes a thin film 1221 and another conductive layer 1222 disposed on the thin film 1221. The conductive layers 1212 and 1222 are disposed opposite to each other, and they can be made of ITO (indium tin oxide). The conductive glass substrate 121 and the conductive film 122 are separated from each other by a spacer 123. This configuration can prevent the undesired contact of the conductive layers 1212 and 1222 as the user does not operate the touch input panel 12, thereby decreasing the misjudgment of touch input.

The conventional touch input panel 12 is usually cooperated with the display device 11. For example, the display device 11 can display an object so that the user can aim at and click the corresponding area of the touch input panel 12. Otherwise, the display device 11 may display the cursor so that the user can control to move the cursor. If the touch screen 1 functions as a keyboard, it is necessary to show the entire or most keys on the display device 11 so that the user can touch the specific area of the touch input panel 12 corresponding the shown key so as to key in the desired letter. This method is to show a virtual keyboard on the touch screen 1 instead of forming physical buttons on the touch input panel 12.

The conventional touch input panel 12 must cooperate with the display device 11 to provide the recognizable buttons for the user to clearly and correctly press the corresponding area(s), thereby generating the correct key signal. In other words, the conventional touch input panel 12 can not be used as a complete input device by itself.

Therefore, it is an important subject of the present invention to provide a touch input module that can be operated independently and capable of key input and track input functions.

### SUMMARY OF THE INVENTION

In view of the foregoing subject, an objective of the present invention is to provide a touch keypad module and an input processing method which are capable of key input and track input functions.

To achieve the above objective, a touch keypad module of the present invention includes a touch input panel, which has a touch input surface and physically shows a plurality of input areas. The input areas are defined as the areas on the touch input surface capable of generating effective inputs in a key input mode. The touch input panel operates in the key input mode or a track input mode according to a mode control signal, and processes at least an input signal inputted through the touch input surface.

To achieve the above objective, an input processing method of a touch keypad module is disclosed in the present invention. The touch keypad module includes a touch input panel which has a touch input surface and physically shows a plurality of input areas. The input areas are defined as the areas on the touch input surface capable of generating effective inputs in a key input mode. The method comprises an input step, inputting at least an input signal through the touch input surface; and a processing step, processing the input signal by whether a key input mode or a track input mode according to a mode control signal.

In one embodiment, the input areas are physically defined on the touch input panel to function as keys. For helping the user's recognition, for example, the input area is configured with a border corresponding to a key and configured with the letter or symbol of the key.

In one embodiment, in the track input mode, the area of the touch input surface capable of generating the effective inputs is not limited to the input areas.

In one embodiment, the input signal in the key input mode is corresponding to a key data, and the input signal in the track input mode is corresponding to a track data.

In one embodiment, the touch input surface has a track input portion and a non-track input portion. The input areas are located within the track input portion and the non-track input portion. In the track input mode, the area of the track input portion capable of generating the effective inputs is not limited to the corresponding input areas, but the area of the non-track input portion capable of generating the effective inputs is limited to the corresponding input areas. Besides, only a portion of the input areas of the non-track input portion is capable of generating the effective inputs. The input signal in the key input mode is corresponding to a key data, and the input signal in the track input mode can be corresponding to a track data and/or a key data.

In one embodiment, the touch keypad module further includes a mode switching unit, which outputs the mode control signal to control the touch input panel to operate in the key input mode or in the track input mode.

In one embodiment, at least one of the input areas functions as a mode switching unit, outputting the mode control signal to control the touch input panel to selectively operate in the key input mode or the track input mode.

In one embodiment, the touch keypad module further includes a processing unit and an output unit. The processing unit operates in the key input mode or the track input mode according to the mode switching signal. The output unit is electrically connected with the processing unit. The processing unit in the key input mode outputs at least a key data through the output unit according to the input signal, and in the track input mode outputs at least a track data through the output unit according to the input signal.

In one embodiment, the key data in the key input mode is generated according to at least a key represented by the input signal. The track data in the track input mode is generated according to at least a touch location represented by the input signal. The key data and the track data both can be generated by the processing unit.

In one embodiment, at least one of the input areas functions as a keypad key in the key input mode, and functions as a cursor key in the track input mode. For example, the input area can be disposed in the non-track input portion and adjacent to the track input portion. Besides, this input area can have at least two portions, which function together as a keypad key in the key input mode, and function as two mouse keys respectively in the track input mode. The mouse keys are a left mouse button and a right mouse button for example. The keypad key can be a space key.

In one embodiment, at least one of the input areas functions as a keypad key in both the key input mode and the track input mode. The keypad key can be a functional key or one key of a key combination. For example, the keypad key represent the key of a standard keyboard such as “Ctrl”, “Alt”, “Esc”, “Shift”, “Enter”, “arrow key”, “Page Up”, “Page Down”, or “Backspace”. Otherwise, the keypad key can be a key of a key combination, such as the “Ctrl” key plus “X” key as cutting function, the “Ctrl” key plus “C” key of copying function, or the “Ctrl” key plus the “V” key of pasting function.

In one embodiment, the touch input panel can operate, according to the mode control signal, in the key input mode or one of the track input modes. For example, the touch input panel can operate in the key input mode (as a keypad), in the first track input mode (as a touchpad or mouse), or in the second track input mode (as a handwriting pad or a digitizer). The outcome of the first track input mode includes displacement data, and the outcome of the second track input mode includes coordinate data. To be noted, at least one input area can function as a keypad key in the key input mode and as a cursor key in the track input mode.

In one embodiment, an interval exists between the input areas.

In one embodiment, the touch input panel is a resistive touch panel or a capacitive touch panel.

In one embodiment, the touch input panel is a flexible touch input panel.

As mentioned above, in the touch keypad module and the input processing method thereof of the present invention, because the touch input panel can be operated in the key input mode or the track input mode selectively, the touch keypad module can provide the key input function and the track input function.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a conventional touch screen;

FIGS. 2A and 2B are schematic diagrams of a touch keypad module of a preferred embodiment of the present invention;

FIGS. 2C and 2D are block diagrams of the touch keypad module in FIGS. 2A and 2B;

FIGS. 3A and 3B are schematic diagrams of a touch keypad module of a preferred embodiment of the present invention;

FIG. 4 is a schematic top-view diagram of partial structure of a touch input panel of a touch keypad module of a preferred embodiment of the present invention;

FIGS. 5A to 5D are schematic diagrams of touch input panels of a touch keypad module of a preferred embodiment of the present invention;

FIGS. 6A to 6D are schematic diagrams of touch keypad modules of preferred embodiments of the present invention;

FIG. 7 is a block diagram of a touch keypad module of a preferred embodiment of the present invention; and

FIG. 8 is a flowchart of an input processing of a touch keypad module of a preferred embodiment of the present invention.

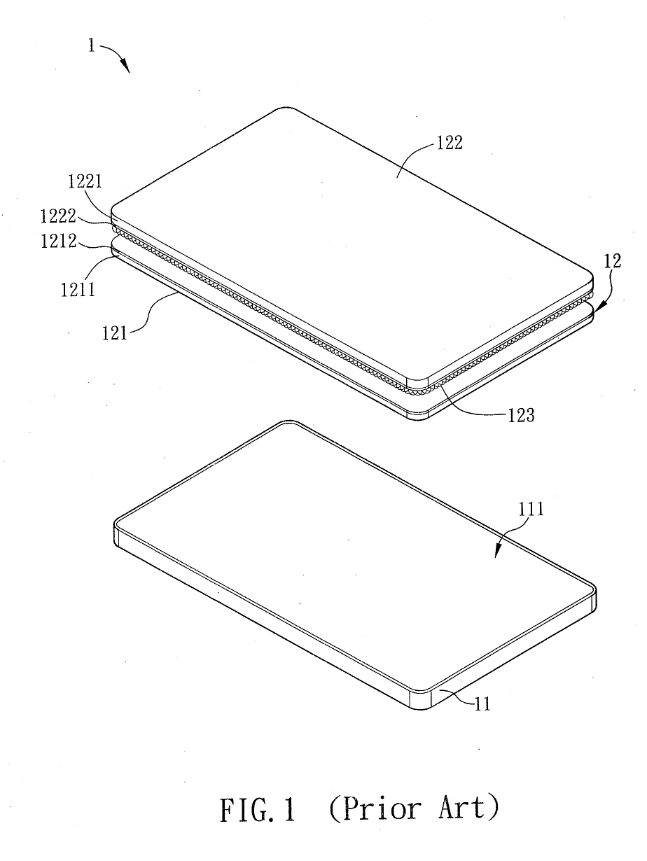

### DETAILED DESCRIPTION OF THE INVENTION

The present invention will be apparent from the following detailed description, which proceeds with reference to the accompanying drawings, wherein the same references relate to the same elements.

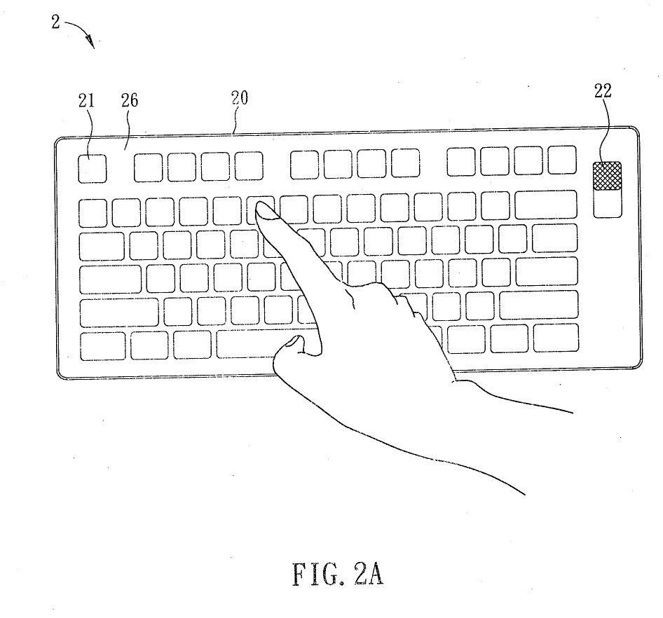

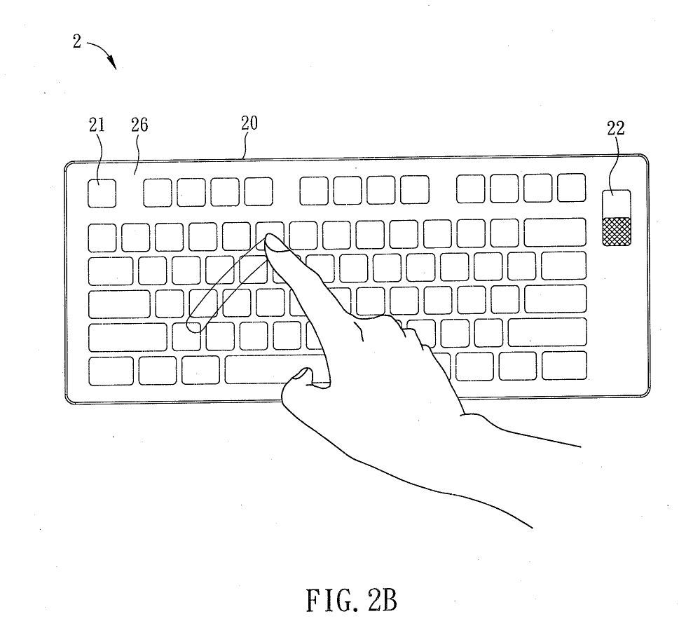

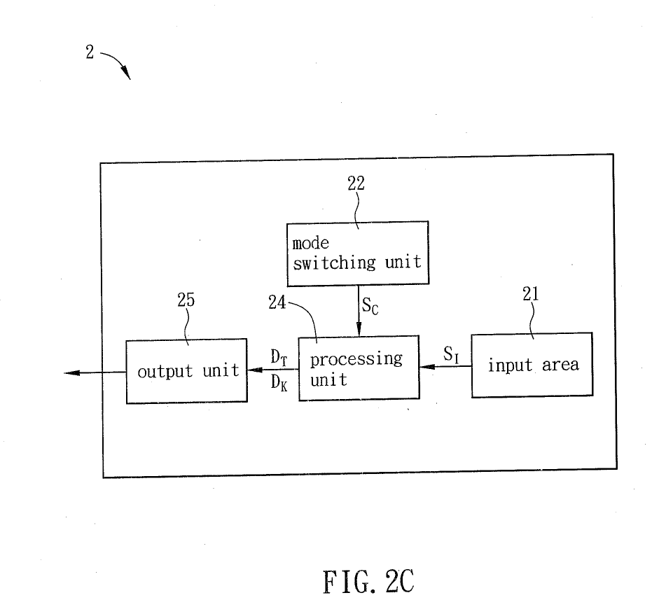

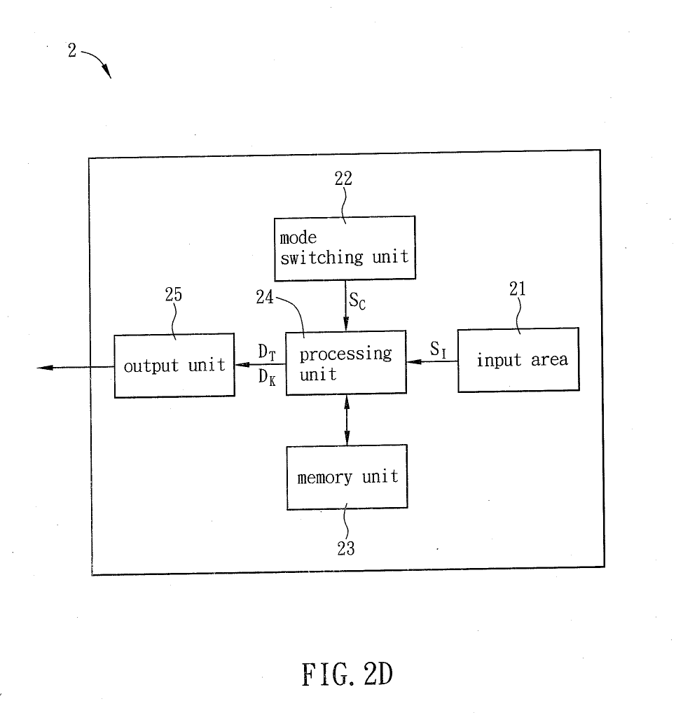

FIGS. 2A and 2B are schematic diagrams of a touch keypad module of a preferred embodiment of the present invention. As shown in FIG. 2A, a touch keypad module 2 includes a touch input panel 20, which has a touch input surface 26 and physically shows a plurality of input areas 21 on the touch input surface 26. Each of the input areas 21 represents at least a corresponding key, and each of the input areas 21 can generate an input signal by the user's touch input. In other words, the touch input panel 20 operates in the key input mode, in which each of the input areas 21 is regarded as an independent key and the input signal generated by each of the input areas 21 is corresponding to the corresponding key. The input areas 21 are defined as areas of the touch input surface 26 capable of generating effective inputs in the key input mode. In the key input mode, the area except the input areas 21 of the touch input surface 26 can not generate effective inputs.

In this embodiment, for the touch keypad module 2, the input areas are not shown by a display apparatus, but directly formed on the touch input panel 20 instead and capable of the independent inputs. In other words, the input areas 21 are physically formed on the touch input panel 20. Each of the input areas 21 can show its corresponding key in many ways, such as forming the key's border and letter or symbol on the inner or outer surface, or on the inner or outer layer, for helping the user's recognition. The above formation can be performed by printing or carving, or by disposing color fluorescent materials or dyes in the input areas 21, and the fluorescent materials or dyes are arranged according to the corresponding letters or symbols.

For example, the touch keypad module 2 can be arranged into a standard keyboard. The touch input panel 20 includes a plurality of input areas 21 representing the standard keys of a standard keyboard, which include “A” to “Z”, F1˜F12, “ALL”, “Ctrl”, “Space”, “Enter”, “Backspace”, “Home”, “End”, “Page Up”, and “Page Down”, or the like. The input areas 21 are configured on the touch input panel 20 at the positions corresponding to the keys of the standard keyboard.

In addition, as shown in FIG. 2B, the touch keypad module 2 can be regarded as a track input device, such as a trackpad or a handwriting pad, and the user can move the finger or a stylus on the touch input surface 26 to generate a track input. In other words, the touch input panel 20 is operated in the track input mode. To be noted, the area of the touch input surface 26 capable of generating the effective inputs is not limited to the input areas 21.

The touch input panel 20 operates in the key input mode (as shown in FIG. 2A) or the track input mode (as shown in FIG. 2B) according to a mode control signal, and then processes at least one input signal generated by the input areas 21. The input signal in the key input mode is corresponding to a key data, and the input signal in the track input mode is corresponding to a track data. The track data can include location information generated by the track input, and the location information describes or records the route of the track input.

In the track input mode, the location information can be represented by coordinates (absolute coordinates or relative coordinates) or displacements. For example, if the touch input panel is partially or totally used as a touchpad capable of the mouse function, the location information is represented by the displacements, and that means the touch keypad module outputs the displacement data according to the user's touch input. If the touch input panel is partially or totally used as a digitizer, the location information is represented by the coordinates, and that means the touch keypad module 2 outputs the coordinate data according to the user's touch input.

The touch input panel 20 can have one or more track input modes, and can operate, according to the mode control signal, in the key input mode or one of the track input modes. For example, the touch input panel 20 can operate in the key input mode (as a keypad), in the first track input mode (as a touchpad or a mouse), or in the second track input mode (as a handwriting pad or a digitizer). The outcome of the first track input mode includes displacement data, and the outcome of the second track input mode includes coordinate data.

In this embodiment, the touch keypad module 2 further includes a mode switching unit 22, which outputs the mode control signal to control the touch input panel 20 to selectively operate in the key input mode (as shown in FIG. 2A) or in the track input mode (as shown in FIG. 2B).

The user can operate the mode switching unit 22 to switch the input mode of the touch input panel 20. For example, the mode switching unit 22 is a switch, and when the switch is on the first location, the touch input panel 20 operates in the key input mode (as shown in FIG. 2A), and when the switch is on the second location, the touch input panel 20 operates in the track input mode (as shown in FIG. 2B).

As shown in FIG. 2C, the touch keypad module 2 further includes a processing unit 24 and an output unit 25. The mode switching unit 22, the processing unit 24 and the output unit 25 can be disposed to the touch input panel 20. The mode control signal S_{C} outputted by the mode switching unit 22 is received by the processing unit 24, and the processing unit 24 selectively operates in the key input mode (as shown in FIG. 2A) or in the track input mode (as shown in FIG. 2B) according to the mode control signal. The output unit 25 is electrically connected with the processing unit 24, and the processing unit 24 in the key input mode receives the input signal S_{I} to output at least a key data D_{K} through the output unit 25. The key data D_{K} can represent the information of at least a key or the combination of a plurality of keys, such as “Ctrl+Alt+Del”. The processing unit 24 in the track input mode receives the input signal S_{I} to output at least a track data D_{T} through the output unit 25. The track data D_{T} can represent a touch of a coordinate point or touches of a plurality of coordinate points. The key data D_{K} and the track data D_{T} can be outputted to an electronic device, such as a desk-top computer, a notebook computer, a tablet computer or the like, or to an electronic device that can receive information, such as a PDA, a smart phone or the like.

In this embodiment, in the key input mode, the key data D_{K} is generated according to at least a key represented by the input signal SI. In the track input mode, the track data D_{T} is generated according to at least a touch location represented by the input signal S_{I}. The key data D_{K} and the track data D_{T} both can be generated by the processing unit 24.

Otherwise, for example, in the track input mode, the track data D_{T} is generated according to touch locations represented by a plurality of input signals S_{I}.

As shown in FIG. 2D, the touch keypad module 2 further includes a memory unit 23. The mode switching unit 22, the memory unit 23, the processing unit 24 and the output unit 25 can be disposed to the touch input panel 20. The processing unit 24 is electrically connected with the memory unit 23, and the memory unit 23 stores the mode control signal. The mode control signal S_{C} outputted by the mode switching unit 22 is received by the processing unit 24. When the mode represented by the control signal S_{C} is changed, the processing unit 24 renews the mode control signal stored by the memory unit 23. The processing unit 24 can operate either in the key input mode (as shown in FIG. 2A) or in the track input mode (as shown in FIG. 2B) according to the mode control signal stored by the memory unit 23.

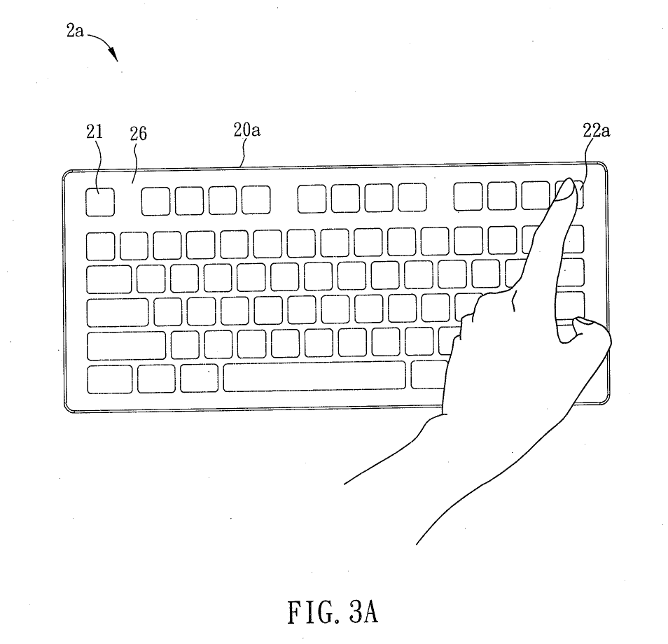

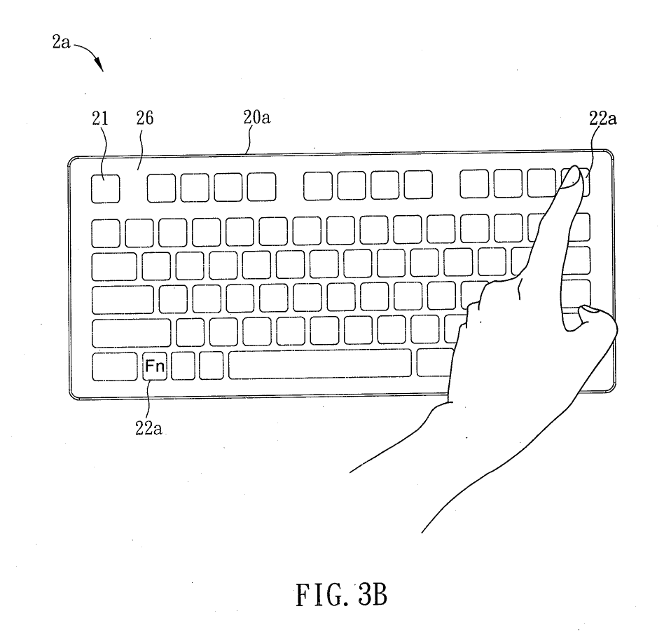

FIGS. 3A and 3B are schematic diagrams of a touch keypad module of another preferred embodiment. In this embodiment, at least one of the input areas of the touch keypad module 2a functions as a mode switching unit 22a, which outputs a mode control signal to control the touch input panel 20a to operate in the key input mode or the track input mode. For example in FIG. 3A, the input area 21 corresponding to the key “F12” of the standard keyboard can be used as the mode switching unit 22a. When the user touches the mode switching unit 22a, this designated input area 21 generates the input signal as the mode control signal S_{C} for switching the present input mode to another input mode, and for example, from the key input mode to the track input mode, or from the track input mode to the key input mode. Otherwise, another key, such as the key located between the keys “Ctrl” and “Alt” also can be used as the mode switching unit 22a. In addition, as shown in FIG. 3B, a functional key “Fn” of an input area 21 and the key corresponding to the key “F12” of the standard keyboard are together used as the mode switching unit 22a. When the user simultaneously touches the two keys of the mode switching unit 22a, the input signal generated by the input area 21 is used as the mode control signal S_{C} for switching the present input mode to another input mode.

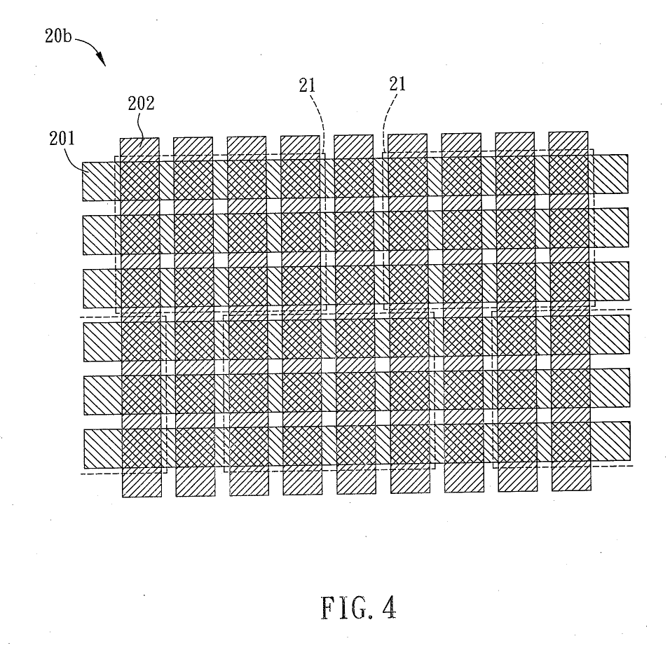

FIG. 4 is a schematic top-view diagram of partial structure of a touch input panel of a touch keypad module of a preferred embodiment of present the invention.

The touch input panel 20b can further include a plurality of row wires 201 and column wires 202, which are intersected with each other. Each of the input areas 21 covers at least one intersection point of the row wires 201 and the column wires 202.

For example in FIG. 4, each of the input areas 21 covers twelve intersection points, but there are three intersection points between the adjacent input areas 21 still not covered by the input areas 21. In other words, an interval exists between the input areas 21, and a portion of the intersection points of the row wires 201 and the column wires 202 is not covered by any input area 21, but covered by the interval instead.

The touch input panel 20b can be a digital matrix resistive touch panel. When touched by the user, the row wire 201 and the column wire 202 will conduct each other at the intersection point so as to generate an input signal that is transmitted to the processing unit through the row wire and the column wire forming the intersection point. Besides, for the touch input panel 20b, different pressures applied by the user can be distinguished for avoiding erroneous touches.

In the key input mode, only the signal generated by the intersection point within the input area 21 is regarded as an effective input, and the signal generated by the intersection point within the interval is not regarded as an effective input, thereby making a simulated key input effect. In the track input mode, the signal generated by the intersection point either within the touch area 21 or within the interval is regarded as the effective input so that the touch input panel can be used as a handwriting pad.

The row wires 201 and the column wires 202 can be made of transparent conductive material, such as indium tin oxide (ITO). Otherwise, the material of the row wires 201 and column wires 202 can be opaque conductive material, such as metal. For example, the all input areas 21 are configured with colored patterns formed by fluorescent or dye material, and the remaining area except the input areas 21 on the outer surface of the touch keypad module 2 is configured with opaque material. Therefore, the user can not see the inner circuit of the touch keypad module 2 from outside. Besides, even if the row wires 201 and the column wires 202 are made of opaque conductive material, they can't be seen by the user so that the touch keypad module 2 can have a more beautiful appearance.

In addition, the touch input panel is not limited to a resistive touch panel or a capacitive touch panel. Besides, the touch input panel can be, but not limited to, a flexible touch input panel.

No matter what kind of the touch input panel is used, the touch input surface of the touch input panel includes a plurality of defined touch input points, such as the above-mentioned intersection points. Each of the touch input point is not covered by two or more input areas. Although the touch input points uncovered by the touch areas are not regarded as the effective touch input points in the key input mode, they can be regarded as the effective touch input points in the track input mode.

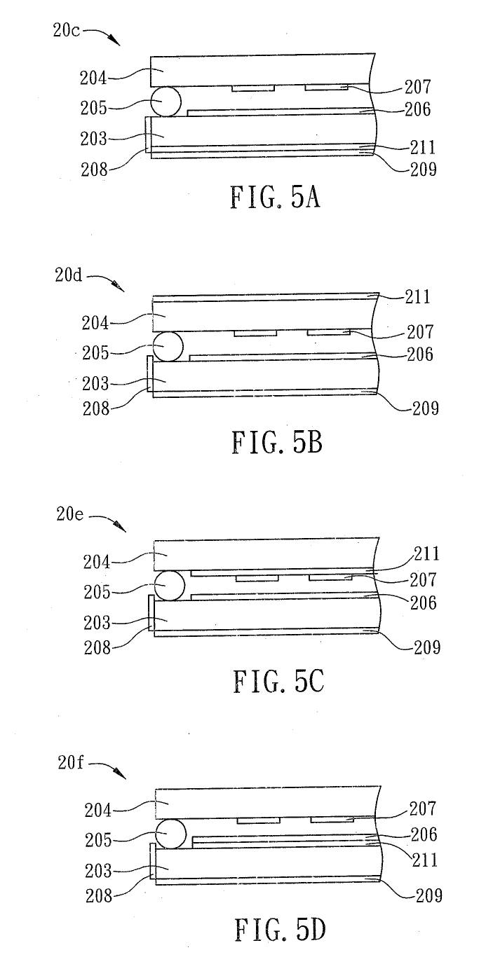

FIGS. 5A to 5D are schematic diagrams of touch input panels of a touch keypad module of a preferred embodiment of the present invention. As shown in FIGS. 5A to 5D, each of the touch input panels 20c-20f can be a resistive touch panel or a capacitive touch panel. Each of the touch input panels 20c-20f mainly includes a first board 293 and a second board 204, and the first and second boards 203 and 204 are separated by a spacer 205. The inner sides of the boards 203 and 204 include the conductive layers 206 and 207, respectively. The conductive layers 206 and 207 can be patterned into a plurality of row wires and column wires.

The two boards 203 and 204 can be substrates or films, or a substrate and a film. For example, the first board 203 is a glass substrate, and the second board 204 is a film, and the user can touch the second board 204 to input information. Further, for example, the first and second boards 203 and 204 are both films. The substrate can be a glass substrate or a plastic substrate, and the material of the board can include Polymethylmethacrylate (PMMA) or Polycarbonate (PC).

The pattern 211 of each input area 21 can be formed on the first board 203 or the second board 204 by printing. The material of the pattern can be fluorescent material or dye material, arranged in conformity with the corresponding letters or symbols.

The pattern 211 can be disposed on the outer surface of the first board 203 or the second board 204. As shown in FIG. 5A, the pattern 211 is disposed on the outer surface of the first board 203. As shown in FIG. 5B, the pattern 211 is disposed on the outer surface of the second board 204.

In addition, the pattern 211 also can be disposed at the inner surface of the first board 203 or the second board 204, and then the conductive layer is disposed on the pattern 211. As shown in FIG. 5C, the pattern 211 is disposed on the inner surface of the second board 204, and then the conductive layer 207 is formed on the pattern 211. As shown in FIG. 5D, the pattern 211 is disposed on the inner surface of the first board 203, and then the conductive layer 206 is formed on the pattern 211.

A backlight module including a light-emitting unit and a light-guiding plate can be disposed at an edge part or outer side of the first board 203 as shown in FIGS. 5A to 5D. For example, the backlight module includes at least a light-emitting device 208 and a light-guiding plate 209. The light-guiding plate 209 can be disposed at the outer side of the first board 203 as shown in FIGS. 5A to 5D. The light-emitting device 208 can be disposed at the edge part of the first board 203 as shown in FIGS. 5A to 5D, and can be a light-emitting diode (LED) device for example. The light emitted by the light-emitting device 208 enters into the first board 203 through the edge side of the first board 203, and then the light-guiding plate 209 guides the light so that the light is emitted through the inner side of the first board 203. Subsequently, the light passes through the pattern 211 and then passes through the outer side of the second board 204 so that the user can see the content of the pattern 211.

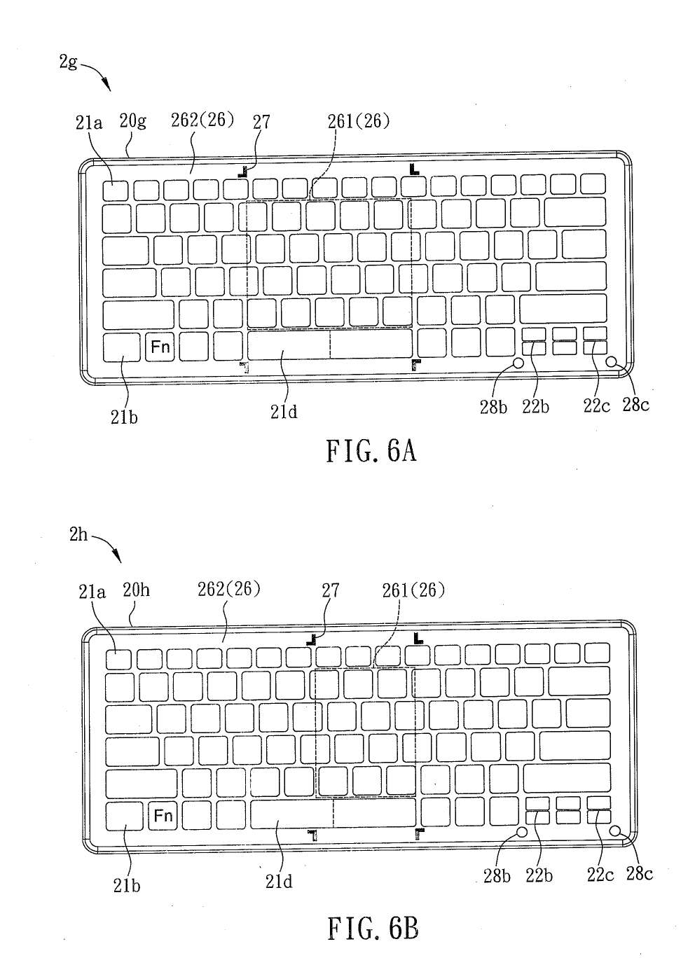

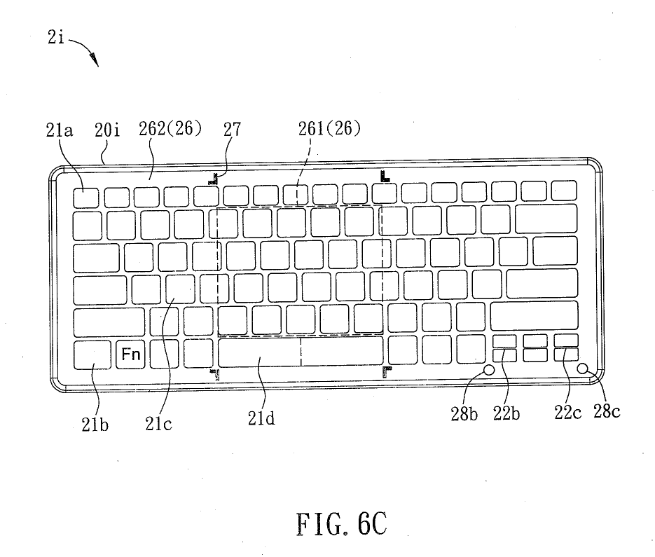

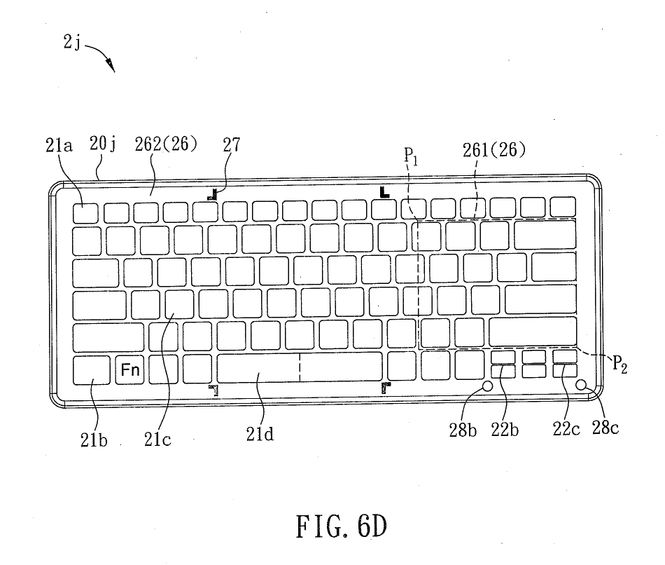

FIGS. 6A to 6C are schematic diagrams of touch keypad modules of other preferred embodiments of the present invention. As shown in FIGS. 6A to 6C, the touch input surface 26 of the touch input panels 20g˜20i of the touch keypad modules 2g˜2i has a track input portion 261 and a non-track input portion 262. The input areas 21 are located within the track input portion 261 and the non-track input portion 262. In the key input mode, the area in the track input portion 261 and the non-track input portion 262 that can generate the effective inputs is limited to the corresponding input areas 21. Besides, the entire touch input surface 26 is used as a keypad.

In the track input mode, the area of the track input portion 261 that can generate the effective inputs is not limited to the corresponding input areas 21, but the area of the non-track input portion 262 that can generate the effective inputs is limited to the corresponding input areas 21. For example, the track input portion 261 of the touch input surface 26 can be used as a track input apparatus, such as a handwriting pad, a touchpad, or a digitizer. The input area 21 of the non-track input portion 262 can be used as a hot key or a functional key. For example, the input area (key) 21b of the non-track input portion 262 functions the same as the key “Ctrl” of the standard keyboard, and the input area (key) 21a of the non-track input portion 262 functions the same as the key “Esc” of the standard keyboard. Other keys, such as “Alt”, “Esc”, “Shift”, “Enter”, “arrow key”, “Page Up”, “Page Down”, “backspace”, etc., can still function in the track input mode. In other words, at least one input area functions as a key in the key input mode and the track input mode, and the key can be a functional key.

Besides, for the non-track input portion 262, it can be allowed that only a portion of the input areas 21, such as a composite key or a functional key, can generate the effective inputs. The composite key here means the key that can provide a special function with the cooperation of another key. For example, the “X” key can provide a cutting function when cooperated with the key “Ctrl”, the “C” key can provide a copy function when cooperated with the key “Ctrl”, and the “V” key can provide a paste function when cooperated with the key “Ctrl”. The remaining input areas 21 of the non-track input portion 262 can't generate the effective input signals.

In one embodiment, at least an input area 21d functions as a key of a keypad in the key input mode, and functions as a cursor key in the track input mode. The input area 21d can be disposed in the non-track input portion 262 and adjacent to the track input portion 261. Besides, the input area 21d can have at least two portions, which function together as a keypad key in the key input mode, and function as two mouse keys respectively in the track input mode. The mouse keys are a left mouse button and a right mouse button for example. The keypad key can be a space key.

Besides, the mode switching units 22b and 22c can be disposed adjacent to the arrow keys. For example, the mode switching units 22b and 22c can respectively function as two triggers to enter into the key input mode and the track input mode. Besides, the mode switching units 22b and 22c include the keys adjacent to the arrow keys, and can further cooperate with the functional key “Fn”. That means the user needs to simultaneously touch the mode switching unit and the functional key “Fn” to enter into the corresponding input mode. For example, simultaneously touching the mode switching unit 22b and the functional key “Fn” represents entering into the key input mode, and simultaneously touching the mode switching unit 22c and the functional key “Fn” represents entering into the track input mode.

The touch input panel 20g can further include mode indicators 28b and 28c, and for example, they can each include at least a light-emitting diode device. The mode indicators 28b and 28c represent that the touch input panel 20g operates in the key input mode and the track input mode, respectively. The mode indicators 28b and 28c can be designed to emit light at different times.

The touch input panel can operate in two or more modes. It can operate in the key input mode or each of the two or more track input modes. The mode switching units can function as the triggers to enter into different track input modes. For example, when the mode switching units 22b and 22c are not turned on, the touch input panel 20g operates in the key input mode, and the mode indicators 28b and 28c are turned off. When the mode switching unit 22b is turned on while the mode switching unit 22c is turned off, the touch input panel 20g operates in the first track input mode, and the mode indicators 28b is turned on while the mode indicator 28c is turned off. When the mode switching unit 22c is turned on while the mode switching unit 22b is turned off, the touch input panel 20g operates in the second track input mode, and the mode indicator 28c is turned on while the mode indicator 28b is turned off. The mode switching units 22b and 22c also can cooperate with the functional key “Fn”, and that means the user simultaneously touches the mode switching unit and the functional key “Fn” to enter into the corresponding input mode. In the key input mode, the touch input panel 20g functions as a keypad. In the first track input mode, the touch input panel 20g functions as a touchpad capable of a mouse function. In the second track input mode, the touch input panel 20g functions as a digitizer. For example, in the first track input mode (as a touchpad or a mouse), the touch input panel 20g outputs the displacement data according to the touch input, and at least an input area can be used as a cursor key, and this input area still functions as a keypad key in the key input mode. In the second track input mode, the touch input panel 20g outputs the coordinate data according to the touch input.

Besides, the touch input panel 20 has a physical mark 27, which roughly indicates the border of the track input portion 261. Specifically, the mark 27 can have an “L” shape as shown in FIGS. 6A to 6C, or a right-angle shape (like an inverse “L” or a “7”), or a shape of a triangle, a quarter circle, a sector, a line, a dot or any shape, or a shape of the combination of the above-mentioned shapes.

In FIG. 6A, the mark 27 is aligned with the input area 21d representing the “space” key, and the left and right borders of the track input portion 261 are aligned with the “space” key.

In FIG. 6B, only the right mark 27 is aligned with the “space” key, and the left mark 27 is aligned with the “V” key of the standard keyboard. Besides, the right border of the track input portion 261 is aligned with the “space” key, and the left border thereof is aligned with the “V” key. The keys “Ctrl”, “X”, “C”, and “V” defined in the standard keyboard can be used as hot keys. The input areas 21 in the track input portion 261 and the non-track input mode 262 that can provide the hot key function can operate simultaneously. For example, the user can use one hand to operate the track input portion 261 to select an object or a range, and use the other hand to operate the key “Ctrl”, “X”, “C” or “V” to perform the function of cutting, copying or pasting.

In FIG. 6C, the mark 27 is aligned with the “space” key, and the left and right borders of the track input portion 261 are aligned with the “space” key. The input area 21c of the non-track input portion 262 can be used as a single key providing the function that is achieved by a key combination, providing the function of cutting, copying or pasting for example. Therefore, the user can use a single hand to operate the track input portion 261 to select an object or a range and also operate the input area 21c to perform a special function.

For the touch input panels 20g-20i as shown in FIGS. 6A to 6C, the input signal in the key input mode is corresponding to a key data, and the input signal in the track input mode can be corresponding to a track data and/or a key data.

In addition, the track input portion 261 is not limited to the central part of the touch input panels 20g˜20i, and it can be disposed at other locations of the touch input panels 20g˜20i. For example, it can be disposed on the right part, left part or the edge part of the touch input panels 20g˜20i.

Furthermore, the location of the track input portion 261 can be changed. The user can set or select the location and range of the track input portion 261 by himself. As shown in FIG. 6D, the user can select two points P1 and P2 on the touch input panel 20j, and these two points P1 and P2 not only indicate the location of the track input portion 261, but also constitute a rectangle indicting the range of the track input portion 261.

In addition, the touch keypad module can provide plural options of the location of the track input portion for the user. For example, the touch keypad module 2 provides two options to locate the track input portion 261 as shown in FIGS. 6A and 6B, and the user can select one of the options to set the location of the track input portion 261. Furthermore, the touch keypad module 2 can set one of the options as a default setting, and for example, set the location as shown in FIG. 6A to a default location, and that means the track input portion 261 is disposed at the location as shown in FIG. 6A. If need be, the user can switch to set the track input portion 261 as shown in FIG. 6B.

Accordingly, the touch input panel of the present invention includes a touch input surface and shows physically a plurality of input areas. The touch input surface has a defined track input portion and a defined non-track input portion, and the input areas are located within the track input portion and the non-track input portion. The track input portion and the non-track input portion are not overlapped with each other. The track input portion can be defined or changed by the user, and the location and range thereof can be varied according to the practical requirements. In other words, the location and range of the track input portion can be varied according to the user's command.

For example, the touch input panel 20j can operate in the key input mode or one of three track input modes. In addition to the above-mentioned operation situations, the mode switching units 22b and 22c can provide another one that the touch input panel 20j operates in the third track input mode when the mode switching units 22b and 22c are both turned on. This is the mode allowing user's setting, and the use can define or change the location or range of the track input portion, and set the track input portion as a touchpad, a mouse, a handwriting pad or a digitizer.

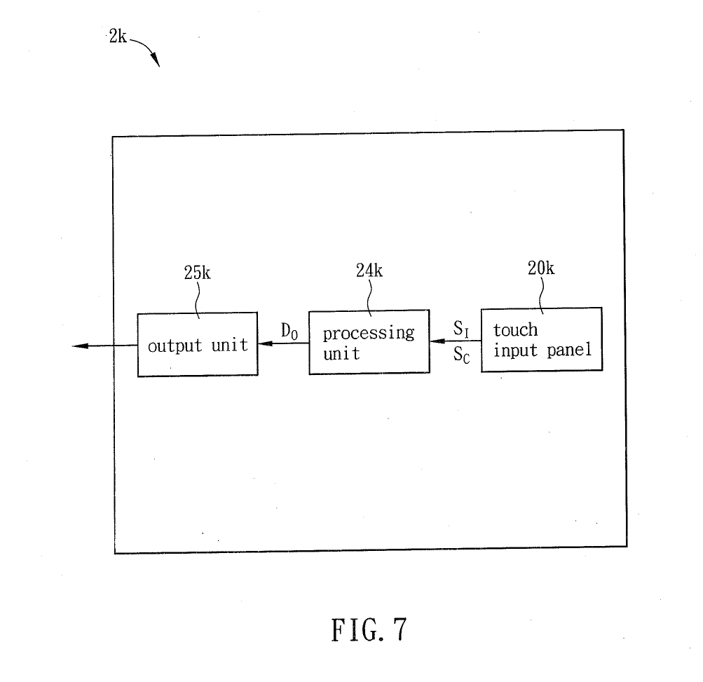

FIG. 7 is a block diagram of a touch keypad module of a preferred embodiment of the present invention. As shown in FIG. 7, the touch keypad module 2k includes a touch input panel 20k, a processing unit 24k and an output unit 25k. The output unit 25k is coupled with an electronic device. The mode control signal S_{C} outputted by the mode switching unit 22 of the touch input panel 20k is received by the processing unit 24k. When the mode represented by the mode control signal S_{C} is changed, the processing unit 24k, according to the mode control signal SC, determines that the following input signal S_{I} is processed so as to output the output data D_{O} in input mode or the track input mode. For example, the key input mode is a keypad mode while the track input mode includes two modes, a mouse mode and a handwriting pad mode, and the processing unit 24k determines that the following input signal S_{I} is processed so as to output the output data D_{O} in the keypad mode, the handwriting pad mode or the mouse mode. The processing unit 24k outputs the output data D_{O} to a calculation device through the output unit 25k. Whether the key input mode or the track input mode, the input signal corresponding to the inside or the outside of the input area is processed to output the output data D_{O} to a calculation device through the touch input panel 20k. Then, the calculation device can understand the format of the input signal from the output data D_{O} so as to be able to properly deal with the output data D_{O}.

Furthermore, in the above embodiments, the touch keypad modules are configured as, for example but not limited to, a standard keyboard. The touch keypad module can be configured with a proper arrangement according to the practical requirements, and for example, with a numeral keypad arrangement. Besides, the touch input panel can be a flexible panel.

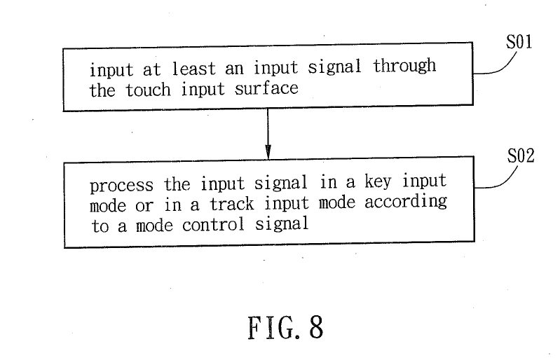

As shown in FIG. 8, an input processing method of a touch keypad module of a preferred embodiment of the present invention includes an input step S01 and a processing step S02. The touch keypad module includes a touch input panel that has a touch input surface and physically shows a plurality of input areas. The input areas are defined as the areas on the touch input surface capable of generating effective inputs in a key input mode. The input step S01 is to input at least an input signal through the touch input surface. The processing step S02 is to process the input signal in a key input mode or in a track input mode according to a mode control signal.

The input processing method of this embodiment can be applied to any touch keypad module of the above-mentioned embodiments. The variations and details of this input processing method are similar to the operation and processing of the touch keypad modules of the above embodiments, so the detailed descriptions are omitted here.

In summary, in the touch keypad module and the input processing method thereof of the present invention, because the touch input panel can be operated in the key input mode or the track input mode selectively, the touch keypad module can provide a key input function and a track input function.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch keypad module, comprising:
a touch input panel including a touch input surface and physically showing a plurality of input areas which are defined as the areas on the touch input surface capable of generating effective inputs in a key input mode,
wherein the touch input panel selectively operates in the key input mode or a track input mode according to a mode control signal, and processes at least an input signal inputted through the touch input surface.

2. The touch keypad module as recited in claim 1, wherein in the track input mode, the area on the touch input surface capable of generating the effective inputs is not limited to the input areas.

3. The touch keypad module as recited in claim 2, wherein the input signal in the key input mode is corresponding to a key data, and the input signal in the track input mode is corresponding to a track data.

4. The touch keypad module as recited in claim 1, wherein the touch input surface includes a track input portion and a non-track input portion, the input areas are disposed within the track input portion and the non-track input portion, the area of the track input portion capable of generating the effective inputs in the track input mode is not limited to the corresponding input areas, and the area of the non-track input portion capable of generating the effective inputs in the track input mode is limited to the corresponding input areas.

5. The touch keypad module as recited in claim 4, wherein the track input portion is disposed at the central part, the right part, the left part or the edge part of the touch input panel, and the location and the range of the track input portion are changeable by a user's command.

6. The touch keypad module as recited in claim 1, further comprising:
a mode switching unit outputting the mode control signal for controlling that the touch input panel operates in the key input mode or the track input mode.

7. The touch keypad module as recited in claim 1, wherein at least one of the input areas functions as a mode switching unit, outputting the mode control signal for controlling that the touch input panel operates in the key input mode or the track input mode.

8. The touch keypad module as recited in claim 1, further comprising:
a processing unit operates in the key input mode or the track input mode according to the mode switching signal; and
an output unit electrically connected with the processing unit,
wherein the processing unit in the key input mode outputs at least a key data through the output unit according to the input signal, and in the track input mode outputs at least a track data through the output unit according to the input signal.

9. The touch keypad module as recited in claim 8, wherein the processing unit in the key input mode generates the key data according to at least a key represented by the input signal, and in the track input mode generates the track data according to at least a touch location represented by the input signal.

10. The touch keypad module as recited in claim 1, wherein at least one of the input areas functions as a keypad key in the key input mode, and functions as a cursor key in the track input mode.

11. The touch keypad module as recited in claim 10, wherein at least one of the input areas includes at least two portions, which function together as the keypad key in the key input mode, and function as two mouse keys respectively in the track input mode.

12. The touch keypad module as recited in claim 10, wherein the keypad key is a space key.

13. The touch keypad module as recited in claim 1, wherein at least one of the input areas functions as a keypad key in both the key input mode and the track input mode.

14. The touch keypad module as recited in claim 13, wherein the keypad key is a functional key or one key of a key combination.

15. The touch keypad module as recited in claim 1, wherein an interval exists between the input areas, and the touch input panel further comprises:
a plurality of row wires and column wires intersected with each other, wherein each of the input areas covers at least an intersection point of the row wires and the column wires.

16. The touch keypad module as recited in claim 1, wherein the touch input panel is a resistive touch panel or a capacitive touch panel.

17. The touch keypad module as recited in claim 1, wherein the touch input panel is a flexible touch input panel.

18. An input processing method of a touch keypad module including a touch input panel which has a touch input surface and physically shows a plurality of input areas, wherein the input areas are defined as the areas on the touch input surface capable of generating effective inputs in a key input mode, and the method comprises:
an input step, inputting at least an input signal through the touch input surface; and
a processing step, selectively processing the input signal in a key input mode or in a track input mode according to a mode control signal.

19. The input processing method as recited in claim 18, further comprising:
a generating step, generating the mode control signal by a mode switching unit or at least one of the input areas.

20. The input processing method as recited in claim 18, wherein the processing step comprises:
outputting at least a key data according to the input signal in the key input mode; and
outputting at least a track data according to the input signal in the track input mode through an output unit.

21. The input processing method as recited in claim 20, wherein in the key input mode the key data is generated according to at least a key represented by the input signal, and in the track input mode the track data is generated according to at least a touch location represented by the input signal.

22. The input processing method as recited in claim 20, wherein the touch input panel is a flexible touch input panel.
